(19) United States
(12) Patent Application Publication
(10) Pub. No.: US 2024/0168456 A1
(43) Pub. Date: May 23, 2024

(54) APPARATUS FOR GENERATING A LIBRARY OF PHYSICAL PROPERTIES OF PERIODICALLY STRUCTURED POROUS BODIES AND A CONTROL FILE FOR MANUFACTURING A PHYSICAL PART

(71) Applicant: BASF SE, Ludwigshafen am Rhein (DE)

(72) Inventor: Florian FISCHER, Ludwigshafen am Rhein (DE)

(21) Appl. No.: 18/282,638

(22) PCT Filed: Mar. 18, 2022
(86) PCT No.: PCT/EP2022/057194

§ 371 Date: Sep. 18, 2023

(30) Foreign Application Priority Data
Mar. 19, 2021 (EP) 21163823.4

(51) Int. Cl. G05B 19/4099

(52) U.S. Cl. CPC G05B 19/4099; G05B 2219/49023

(57) ABSTRACT

The invention refers to an apparatus (110) for generating a library of physical properties of structured porous bodies and use the library to generate a control file for additive manufacturing of physical components comprising the structural porous bodies. The apparatus comprises a providing unit (111) for providing structural representations for a plurality of structured porous bodies, wherein a structural representation is indicative of a structure of a structured porous body. A providing unit (112) is adapted to provide a material model, wherein the material model is indicative of a response of a material to one or more external physical influences. A determination unit (113) is adapted to determine physical properties for the structured porous bodies, wherein a physical property for a structured porous body is determined based on the structural representation of the structured porous body and the material model. Further, a generation unit (114) is adapted to generate a library based on the physical properties determined for the structured porous bodies. The library is used to generate a control file to be used by a 3D printer for manufacturing the product.

### FIELD OF THE INVENTION

The invention refers to an apparatus, a method and a computer program for generating a library of physical properties of periodically structured porous bodies. Further, the invention refers to a library system and a printing system comprising the apparatus and to a use of the apparatus, the method and the computer program product for the generation of structured porous bodies.

### BACKGROUND OF THE INVENTION

In recent years, it has been found that for many products it is advantageous to replace conventional construction materials and structures by structured porous bodies made, for instance, of a polymer. Such structured porous bodies have the advantage with respect to conventional materials that they can be easily manufactured by using, for instance, 3D printing methods, and further can provide the same material properties of the conventional components while at the same time reducing the weight of the components substantially. However, finding the right structured porous bodies for a specific application from the plurality of possibilities of the structure and formation of these bodies can be a time-consuming and cumbersome task. In most cases, this task is mainly based on the experiences of the respective engineer to select from the wide varieties of structured porous bodies suitable examples. These examples are then produced, for instance, printed, and tested with respect to the desired properties. Based on these tests, the engineer will then again, based on his/her experience, amend the structure properties of the structured porous bodies and select new examples for further testing until a suitable structured porous body has been found. It will thus be advantageous to provide a possibility to select suitable structured porous bodies in a more effective and less time-consuming manner and integrate such selection into the generation of a control file for producing respective bodies.

### SUMMARY OF THE INVENTION

It is an object of the present invention to provide an apparatus, a method, and a computer program product that allow for the selection of suitable structured porous bodies and the generation of a control file for manufacturing a physical component made of structured porous bodies in a more efficient and less time-consuming manner. Further, it is an object of the present invention to provide a library system and a printing system utilizing the apparatus.

In a first aspect of the present disclosure, an apparatus for generating a library of physical properties of periodically structured porous bodies that are utilizable for physical components is presented, wherein the apparatus comprises a) a periodically structured porous body providing unit for providing structural representations for a plurality of periodically structured porous bodies, wherein a structural representation is indicative of a structure of a periodically structured porous body, b) a material model providing unit for providing a material model, wherein the material model is indicative of a response of a material to one or more external physical influences, c) a physical property determination unit for determining physical properties for the plurality of periodically structured porous bodies, wherein a physical property for a periodically structured porous body is determined based on the structural representation of the periodically structured porous body and the material model, and d) a library generation unit for generating a library of the physical properties of the plurality of periodically structured porous bodies based on the physical properties determined for the plurality of periodically structured porous bodies.

Since the physical property determination unit is adapted to determine physical properties for a plurality of periodically structured porous bodies based on the structural representations of the periodically structured porous bodies and the material model and further since the library generation unit is adapted to generate a library of the physical properties of the plurality of periodically structured porous bodies, cumbersome and time-consuming physical tests of possible suitable periodically structured porous bodies can be avoided and a suitable periodically structured porous body can directly be selected from the library based on the determined physical properties. This allows for a faster and less time-consuming determination of a suitable periodically structured porous body for an intended application.

Periodically structured porous bodies generally comprise a three-dimensional network of node points connected to one another by struts or a three-dimensional network of walls, and a void volume present between the struts or walls. For example, periodically structured porous bodies can refer to triple periodic minimal surfaces (TPMS) or lattice structures. Preferably, the periodically structured porous bodies are periodically structured such that they comprise a unit cell that repeats in at least two dimensions.

The periodically structured porous body providing unit is adapted to provide structural representations for a plurality of periodically structured porous bodies. In particular, the structured porous body providing unit can be a storing unit on which the structural representations for the plurality of periodically structured porous bodies are already stored. However, the structured porous body providing unit can also refer to a receiving unit adapted to receive the structural representations, for instance, from a storage unit or from an input unit, and to provide the received structural representations.

A structural representation of a periodically structured porous body can refer to any information that is indicative of the structure of the respective periodically structured porous body and thus allows to reproduce a structure of the respective periodically structured porous body, for instance, that allows for a virtual reconstruction of the periodically structured porous body. Preferably, the structural representation of a periodically structured porous body comprises structural parameters representing a geometrical shape of the periodically structured porous body. In particular, it is preferred that the structural parameters are indicative of at least one of a lattice type, a lattice parameter, a lattice constant, a beam diameter, a unit cell size, an aspect ratio, a beam angle and a wall thickness.

The material model providing unit is adapted to provide a material model. Also the material model providing unit can refer to a storage unit on which the material model is already stored. However, the material model providing unit can also refer to a receiving unit adapted to receive the material model, for instance, from a storage unit or an input unit, and to provide the received material model.

The material model is indicative of a response of a material to one or more external physical influences. For instance, the material model can refer to a functional relationship between an external physical influence and the response of the material. However, the material model can also refer to a more complex numerical model simulating the response of the material to one or more external physical influences based on known physical laws and respective functional properties of the material. Moreover, the material model can even refer in a simple embodiment to a lookup table or matrix in which already known responses of the material to one or more external physical influences are already stored and can be retrieved from the lookup table or matrix.

The material model can for example be adapted to determine a response of a material to a defined temperature change, for instance, the material model can be adapted to indicate a deformation of the material based on the defined temperature change. Moreover, the material model can be adapted to indicate a deformation of a material, for instance, its elongation, based on a defined applied external force utilizing, for instance, a known strain relation. Such material models already exist for many materials and applications and can be easily adapted for being utilizable in the apparatus, for example, material models as provided in a database by LS-DYNA can be utilized. In many cases, such material models can be generated based on mechanical test data of respective material test specimens that are subjected to the respective physical influences. The test data can then be numerically modelled to numerically describe the response of the material to the respective physical influences.

The physical property determination unit is adapted to determine physical properties for the plurality of periodically structured porous bodies. The physical properties can refer to any physical property of a periodically structured porous body. Preferably, the determined physical properties of a periodically structured porous body refer to at least one of a hardness, an E-module, a density, an elongation at break, a compression stiffness at x % compression, a stress at x % elongation, a rebound, a shore hardness, a flex-modulus, a tensile strength, an impact strength, a Poisson's ratio, a tear strength, and a temperature capacity.

The physical property, for instance, any of the above-mentioned physical properties, for a periodically structured porous body is determined based on the structural representation of the periodically structured porous body and based on the material model. For example, the physical property determination unit can utilize artificial intelligence methods for determining the physical property for a periodically structured porous body when as input the structural representation of the periodically structured porous body is provided. The material model can in this case be an integral part of the artificial intelligence, for instance, can be part of the neural network used for determining the physical property. In particular, for such an exemplary case a suitable artificial intelligence method, for instance, a neural network, a deep learning network, etc., can first be trained by providing different structural representations to the neural network and further the outcomes of respective experiments that lead to the respective physical property. Based on this learning input, the artificial intelligence can be trained to determine the respective physical property simply based on the input of the structural representation of the periodically structured porous body provided as input, wherein the material model is in this case part of the trained artificial intelligence. The trained artificial intelligence can then be utilized by the physical property determination unit. However, the physical property determination unit can also be adapted to use, for instance, known simulation methods, like finite element analysis methods, to determine based on the structural representation and the material model a physical property of the periodically structured porous body.

The library generation unit is then adapted to generate a library of the physical properties of the plurality of periodically structured porous bodies based on the physical properties determined for the plurality of periodically structured porous bodies. In particular, a library refers to a computational structure that interconnects determined physical properties to the respective periodically structured porous body of the plurality of periodically structured porous bodies. This allows to search the library for one or more of the physical properties such that the library provides as result of the search a respective periodically structured porous body that fulfills one or more of the searched physical properties. In a preferred embodiment, the library comprises a two-dimensional matrix data structure in which each determined physical property is correlated to the respective periodically structured porous body. However, the library can also comprise a more than two-dimensional matrix data structure, for instance, a three-dimensional matrix data structure for cases in which additional dependencies can be determined. For example, physical properties of periodically structured porous bodies can depend on the temperature of the periodically structured porous body. Such an identified additional dependency can also be provided as part of the library, wherein in this case the library generation unit is adapted to generate a matrix data structure comprising as additional dependency dimension the respective identified additional dependency, for instance, the temperature.

In an embodiment, the material model is based on a material utilizable in an additive manufacturing process. This allows that the periodically structured porous bodies to which the library refers can easily be manufactured in an additive manufacturing process. Generally, an additive manufacturing process, including 3D printing or rapid prototyping, refers to any of a variety of processes that manufacture three-dimensional objects by adding in a successive manner constituent raw material. 3D printers add that material through a plurality of successively-applied layers. In these regards additive manufacturing stands in stark contrast to other manufacturing techniques such as casting or molding, fabrication, stamping, and machining. Additive manufacturing processes can accommodate a wide variety of raw materials including metals and plastics. In many cases, the additive manufacturing process utilizes a corresponding additive manufacturing model. Such a model typically comprises a three-dimensional model of the desired object and is typically created using computer-aided design, a 3D scanner, or other related techniques. Additive manufacturing models are typically expressed via corresponding modelling software.

Additive manufacturing processes, in particular 3D printing processes, exist already for a plurality of materials and even more will become available for future additive manufacturing processes. Thus, the material models can refer to any material that can now or in the future be utilized in an additive manufacturing process. Preferably, the material model refers to a material comprising at least one of a thermoplastic polymer (TP) selected from a group consisting of impact modified vinyl aromatic copolymers, thermoplastic styrene-based elastomers (S-TPE), polyolefins (PO), aliphatic-aromatic copolyesters, polycarbonates, thermoplastic polyurethanes (TPU), polyamides (PA), polyphenylene sulfides (PPS), polyaryletherketones (PAEK), polysulfones, polypropylenes (PP), polyesters, like PET, PBT and PETG, and polyethylenes (PE). Preferably, the thermoplastic polymer is selected from the group comprising S-TPE, TPU, PP, polyesters, and polyamides. In particular, it is preferred that the thermoplastic polymer refers to TPU. However, in another preferred embodiment the material can also comprise thermoset polymers polymerized during the additive manufacturing process based on acrylates, epoxies, polyurethane, etc.

In an embodiment, the physical property determination unit is adapted, for determining a physical property of a periodically structured porous body, to simulate a physical event effected on the periodically structured porous body and to determine from a simulated response of the periodically structured porous body to the physical event the physical property. The simulated physical event can refer to any physical event that is suitable to determine the physical property. For example, the physical event can refer to virtually subjecting the periodically structured porous body to a predetermined pressure, a predetermined deformation force, a predetermined temperature change, etc. However, the physical event can also refer to a more complex scenario, for instance, to a fall test in which a fall of the periodically structured porous body from a certain height is simulated, to a breaking test, wherein forces are applied to the periodically structured porous body until a breaking point is reached, to a complex deformation test, in which forces in different directions are subjected to the periodically structured porous body, etc. The physical property determination unit can then be adapted to use, as described above, for instance, artificial intelligence to simulate the physical effect and to determine the simulated response of the periodically structured porous body, wherein from the simulated response the physical property can then be determined. However, as also already described above, also known numerical simulation methods, like finite element methods, finite volume methods, and other suitable numerical methods for simulating forces on mechanical components can be utilized. Preferably, the physical property determination unit is adapted to utilize a finite element method for simulating the physical event and the response of the periodically structured porous body.

In a preferred embodiment, the simulated physical event is part of a simulated physical testing procedure that provides a response indicative of a predetermined physical property. For example, the respective physical testing procedure can refer to a known experimental testing procedure that allows to determine the physical property. In particular, it is preferred that the simulated physical testing procedure is based on a testing procedure as described in an industrial norm. This allows to determine the physical properties such that they are comparable not only to each other but also to the results of respective experiments. Moreover, if an artificial intelligence shall be utilized, in this case experimental results from experiments based on such industrial norms can easily be utilized for training the artificial intelligence.

In an embodiment, the physical property determination unit is further adapted to convert the structural parameters into a digital representation of the respective periodically structured porous body and to determine the physical properties based on the digital representation of the periodically structured porous body. The digital representation of the periodically structured porous body can, for instance, refer to a model of one or more cells of the periodically structured porous body. In particular, the digital representation of the periodically structured porous body can refer to a virtual model of one or a small matrix of cells, e.g. a 3×3×1 matrix of cells, of the periodically structured porous body. In this case, it can easily be assumed that the physical properties of one cell or a small matrix of cells of the periodically structured porous body can also be applied when applying a respective scaling, to a structured porous body comprising more than one cell or more than a small matrix of cells. Preferably, open cells at a boundary of the periodically structured porous body are then specifically taken into account with respective boundary conditions, for instance, with symmetrical or periodical boundary conditions. The digital representation of the periodically structured porous body can be provided in any suitable form, for instance, as a three-dimensional mesh representation, as a point cloud representation, as a net representation, as a surface representation, etc. Preferably, the digital representation refers to a mesh representation of the surface of the periodically structured porous body utilizing, for example, a tet-mesh, hex-mesh or 3mf data format. Moreover, in particular, periodic lattice structures can also be described as an art graph defining each note of the lattice with a point and each beam with a respective start point, end point and radius. In this case, for instance, the digital representation can be stored in an xml, Itcx or inp data format.

In an embodiment, the library generation unit is further adapted to utilize one or more of the determined physical properties of a periodically structured porous body to generate a homogeneous material model referring to a physical model of a homogeneous material with the same physical properties as the periodically structured porous body, wherein the library generation unit can further be adapted to provide the homogeneous material model for a periodically structured porous body as part of the library. A homogeneous material model is provided with the same physical properties than the periodically structured porous body without comprising the complex structure of the periodically structured porous body. For example, a full lattice representation of a lattice structure comprises a representation of each lattice beam, for instance, by a mesh with many mesh elements. In a corresponding homogeneous material model each lattice unit cell is represented by a single cuboid element, for instance, a hexaeder-mesh element. These cuboid elements then given, for instance, via a material model, have the exact same behavior as the lattice unit cells they are representing. Thus, a model made from such cuboid elements behaves the same or at least similar to the full representation of the lattice, but with a strongly reduced number of elements, for instance, with a lower mesh size. Accordingly, homogeneous material models describing a homogeneous material with the same physical properties and thus the same responses to physical events than the periodically structured porous body have the advantage that they are easier to simulate than the full periodically structured porous body with its complex structure. For example, if the periodically structured porous body shall be used for a physical component in a complex product that further has to be tested, it is easier to utilize a respective homogeneous material model of the physical component in the simulation of the industrial product than to utilize the simulated full periodically structured porous body.

In an embodiment the library generation unit further comprises a) a target physical property providing unit for providing a target physical property, wherein the periodically structured porous body providing unit is further adapted to provide the structural representations for the plurality of periodically structured porous bodies based on manufacturing constrains for manufacturing the structured porous body, and b) a target periodically structured porous body determination unit for determining a target periodically structured porous body based on the target physical property and the library, in particular, by determining, based on the library, one or more periodically structured porous bodies that fulfil the one or more target physical properties or fulfil the target physical properties as good as possible.

In another aspect of the disclosure, a periodically structured porous body library system is presented, wherein the periodically structured porous body library system comprises a) a library providing unit for providing a library of physical properties of periodically structured porous bodies generated by the apparatus as described above, and b) a user interface adapted to allow for an interaction of a user with the library.

The library providing unit can be adapted to provide the library by accessing a storage on which the library is stored, for instance, by the library generation unit. However, in another embodiment the library system can also comprise the apparatus for generating the library as described above and the library providing unit can be adapted to provide the library after it has been generated by the library generation unit of the apparatus.

Preferably, the user interface is adapted to allow for a search of the library by providing an input unit adapted to receive an input of a user referring to one or more desired characteristics indicative of a physical property of a periodically structured porous body and a search unit adapted for searching the library for a periodically structured porous body comprising one or more of the desired characteristics based on the determined physical properties and/or the structural parameters and to provide the found periodically structured porous body as output to the user. In particular, the user interface can be adapted to relate the desired characteristics to respective physical properties and/or structural parameters, for instance, based on respective lookup tables or functional relations between the characteristics and the physical properties and/or the structural parameters. The search unit can then be adapted to search the library based on the related physical properties and/or structural parameters and to provide as output periodically structured porous bodies that correspond to one or more of the searched physical properties and/or structural parameters.

In a preferred embodiment, the user interface is adapted to provide selection bars, wherein a position of a selection bar corresponds to a specific value of a physical parameter such that a desired physical property is selectable by moving the selection bars to a respective position, and wherein the search unit is adapted to display a selection of periodically structured porous bodies based on the position of the selection bars. In particular, the displayed selection comprises periodically structured porous bodies that are associated with the respective selected physical properties indicated by the positions of the selection bars.

In an embodiment, the user interface is further adapted to allow to search the library additionally with respect to a manufacturing tolerance of the desired characteristics, wherein the search unit is further adapted to utilize the library to provide a periodically structured porous body together with structural parameters comprising tolerances that fulfill the desired characteristics within the manufacturing tolerances. For example, a user can provide a tolerance for a desired hardness of the periodically structured porous body and the search unit is then adapted to determine a hardness range based on the tolerance and the desired hardness and to search for all periodically structured porous bodies in the library comprising a hardness within this hardness range. If one or more structured porous bodies are found for the hardness range, the respective periodically structured porous bodies are provided as result of the search to the user.

In an embodiment, in addition or alternative to the user interface the library system can comprise a selection unit that is adapted to select a periodically structured porous body from the periodically structured porous bodies being part of the library based on physical properties of the periodically structured porous bodies, structural parameters of the periodically structured porous bodies and/or a physical component to be manufactured as selection criteria and to provide the selected periodically structured porous body. In particular, the selection unit can be provided with respective selection criteria and selection rules and automatically select a periodically structured porous body from the periodically structured porous body library without further input of the user.

In a preferred embodiment, the selection unit and/or the user interface is further adapted to provide a selected periodically structured porous body to a control file generator for generating a control file based on the selected periodically structured porous body for controlling an additive manufacturing of a physical component comprising or being partially made of the periodically structured porous body. Generally, the selected porous body to be provided to the control file generator can be selected automatically, by a user of the library, or in an interaction between the user and the user interface, for instance, during a machine guided user selection process. Preferably, the control file generator is further provided with characteristics of the physical component, for instance, with a virtual model of the physical component and/or respective shape and size parameter of the physical component. The control file generator can then be adapted to implement the selected porous body into the physical component, for example, by completely or partially filling the physical component with the periodically structured porous body and to generate the control file based on such generated modified physical component. In particular, the control file generator is preferably configured to generate a three-dimensional representation of the physical component including the periodically structured porous body. For example, the periodically structured porous body can be a substructure embedded into the three-dimensional shape of the physical component. Based on the three-dimensional representation of the physical component including the periodically structured porous body, the control file generator can further be configured to determine a manufacturing path for the additive manufacturing of the physical component, for instance, comprising the successive application of a plurality of material layers. The control file generator can further be configured to generate the control file such that it comprises further control parameters for the additive manufacturing process of the physical component such as temperature, material selection or other control parameters.

As used herein, the term “control file” can be associated with a three-dimensional model of the physical component partially made of a periodically structured porous body and a manufacturing path for the physical component. The control file can be provided, for instance, in an Additive Manufacturing File (“AMF”) format, e.g., as defined by the “Standard Specification for AMF Format”, Version 1.2, created by the International Organization for Standardization/American Society for Testing and Materials (“ISO/ASTM”), XML-based standard 52915:2013, a Standard Tessellation Language file (“STL”), etc. STL is a binary file or ascii. Generally, a control file can include, for instance, a resolution, minimum chord height, minimum possible angle, step size, manufacturing path based on the three-dimensional model, material or powder selection and other control parameters for additive manufacturing.

In a further aspect of the disclosure, a generation system for generating a control file for additive manufacturing of a physical component comprising or being at least partially made of a periodically structured porous body is presented, wherein the generation system comprises a) a periodically structured porous body library system adapted to provide a selected periodically structured porous body, e.g. as described above, that is adapted for being utilized in an additive manufacturing of the physical component, b) a physical component model providing unit for providing a model of the physical component, and c) a control file generator for generating a control file usable for printing the physical component comprising or being at least partially made of the selected structural porous body based on the provided selected porous body and the provided physical component model, and optionally d) a control file providing unit for providing the control file to a system for manufacturing of the physical component comprising a periodically structured porous body based on the control file.

In a further aspect of the disclosure, a manufacturing system for additive manufacturing of a physical component comprising or being at least partially made of a selected periodically structured porous body is presented, wherein the system comprises a) a control file providing unit for providing a control file of the physical component generated, for instance, by the generation system as described above, b) an additive manufacturing machine adapted to utilize the control file of the physical component comprising or being at least partially made of the selected periodically structured porous body for manufacturing the physical component. The control file of the physical component comprising or being at least partially made of the selected periodically structured porous body can refer to any data structure and/or format that allows for a printing of the physical component with the respective additive manufacturing technique, such as 3D printing. The manufacturing system can further comprise the control file generation system as describe above and the control file providing unit can be adapted to provide the control file generated by the control file generation system.

In a further aspect of the disclosure, a generation apparatus for generating a control file for additive manufacturing of a physical component comprising or being at least partially made of a structural porous body is presented, wherein the apparatus comprises a) a structured porous body providing unit for providing a structural representation for a periodically structured porous body, wherein the structural representation is indicative of a structure of the periodically structured porous body, b) a material model providing unit for providing a material model, wherein the material model is indicative of a response of a material to one or more external physical influences, c) a physical property determination unit for determining physical properties for the periodically structured porous body, wherein a physical property for the periodically structured porous body is determined based on the structural representation of the periodically structured porous body and the material model, and d) a control file generator for generating a control file usable for manufacturing the physical component comprising or being at least partially made of the structural porous body and e) optionally a communication interface for providing the control file to a 3D printer interface. More detailed embodiments of the structure porous body providing unit, the material model providing unit, the physical property determination unit and the control file generator are already described above and the same embodiments and definitions can be applied to these units.

In a preferred embodiment, the control file is generated based on the determined physical property, in particular, based on a verification of the determined physical property. For example, the verification can refer to a comparing of the determined physical property with a target physical property, wherein the control signal is then generated if the determined physical property meets the target physical property within predetermined limits.

In an embodiment, the apparatus further comprises a library generation unit for generating a library of physical properties of a plurality of periodically structured porous bodies based on the physical properties determined for the periodically structured porous body, for example, as described above. Preferably, the control file generator is adapted to generate the control file based on the library.

In a preferred embodiment, the generation apparatus further comprises an optimization unit for optimizing a physical component, wherein the optimization unit is adapted to i) receive a target physical property of a target structured porous body, ii) compare the target physical property with the physical property determined for a periodically structured porous body by the physical property determination unit, and iii) decide, based on the comparison, whether to a) generate an amended structural representation of an amended periodically structured porous body and/or an amended material model, repeating the determination of the physical property by the physical property determination unit, and the comparison or b) select the periodically structured porous body as the target periodically structured porous body for which the control file generator generates the control file.

The generating of an amended structural representation can also refer to a selecting of an amended structural representation from a predetermined plurality of structural representations. However, the generating can also refer to varying one or more structural parameters of the previously provided periodically structured porous body, like varying a cell size, a strut diameter, a lattice type, etc. The variation of the structural parameters can be performed arbitrarily or based on predetermined rules. Such rules can determine a functional relation between the result of the comparison and one or more structural parameters, for example, depending on a difference between the target physical property and the determined physical property a strut size can be increased or decreased.

In an additional or alternative embodiment the optimization unit can be adapted to generate more than one, in particular, a plurality of, amended structural representation of an amended periodically structured porous body and to initiate a determination of a physical property for all generated periodically structured porous bodies by the physical property determination unit to generate a library of periodically structured porous bodies from which a periodically structured porous body fulfilling the target physical property can be selected and a respective control file be generated. In particular, for this embodiment all principles and embodiments described with respect to the generation of a periodically structured porous body library as described above can be applied.

In a further aspect of the disclosure, an apparatus for determining a target periodically structured porous bodies comprising one or more target physical properties is presented, wherein the apparatus comprises a) a target physical property providing unit for providing a target physical property, b) a periodically structured porous body providing unit for providing structural representations for a plurality of periodically structured porous bodies, wherein a structural representation is indicative of a structure of a periodically structured porous body, wherein the plurality of structured porous bodies is provided based on manufacturing constrains for manufacturing the structured porous body, c) a material model providing unit for providing a material model, wherein the material model is indicative of a response of a material to one or more external physical influences, d) a physical property determination unit for determining physical properties for the plurality of periodically structured porous bodies, wherein a physical property for a periodically structured porous body is determined based on the structural representation of the periodically structured porous body and the material model, and e) a library generation unit for generating a library of the physical properties of the plurality of periodically structured porous bodies based on the physical properties determined for the plurality of periodically structured porous bodies, and f) a target periodically structured porous body determination unit for determining a target periodically structured porous body based on the target physical property and the library, in particular, by determining, based on the library, one or more periodically structured porous bodies that fulfil the one or more target physical properties or fulfil the target physical properties as good as possible. For example, a periodically structured porous body of the library can be determined as target periodically structured porous body if a difference between a target physical property and the physical property of the periodically structured porous body is the smallest of all periodically structured porous bodies of the library, i.e. is minimal.

In a further aspect, an interface system for generating a control file for additive manufacturing of a physical component comprising or being at least partially made of a structural porous body is presented, wherein the interface system comprises a generation apparatus as described above, and an interface unit configured to provide an interface with the apparatus.

In a further aspect, a generation method for generating a control file for additive manufacturing of a physical component comprising or being at least partially made of a structural porous body is presented, wherein the method comprises a) providing a structural representation for a periodically structured porous body, wherein the structural representation is indicative of a structure of the periodically structured porous body, b) providing a material model, wherein the material model is indicative of a response of a material to one or more external physical influences, c) determining physical properties for the periodically structured porous body, wherein a physical property for the periodically structured porous body is determined based on the structural representation of the periodically structured porous body and the material model, and d) generating a control file usable for manufacturing the physical component comprising or being at least partially made of the structural porous body.

In a further aspect of the disclosure, a manufacturing system for additive manufacturing of a physical component comprising or being at least partially made of a periodically structured porous body is presented, wherein the manufacturing system comprises a) a control file providing unit for providing a control file, for instance, generated by the generation system or the generation apparatus as described above, and b) an additive manufacturing machine adapted to utilize the control file of the physical component comprising or being at least partially made of a periodically structured porous body for manufacturing the physical component. The manufacturing system can further comprise the control file generation apparatus or the control file generation system as described above and the control file providing unit can be adapted to provide the control file generated by the control file generation apparatus or control file generation system as described above.

In a further aspect of the disclosure, a manufacturing system for manufacturing a physical component comprising or being at least partially made of a periodically structured porous body is presented, wherein the manufacturing system comprises a) a periodically structured porous body library system adapted to provide a selected periodically structured porous body, e.g. utilizing a selection unit as described above, b) a physical component model providing unit for providing a model of the physical component, and c) a control file generator for generating a control file usable for manufacturing the physical component comprising or being at least partially made of the selected periodically structured porous body based on the provided selected periodically structured porous body and the provided physical component model, and d) optionally an additive manufacturing machine adapted to utilize the control file of the physical component comprising or being at least partially made of the selected periodically structured porous body for manufacturing the physical component.

In another aspect of the disclosure, a method for generating a library of physical properties of periodically structured porous bodies that are utilizable for physical components is presented, wherein the method comprises a) providing structural representations for a plurality of periodically structured porous bodies, wherein a structural representation is indicative of a structure of a periodically structured porous body, b) providing a material model, wherein the material model is indicative of a response of a material to one or more external physical influences, c) determining physical properties for the plurality of periodically structured porous bodies, wherein a physical property for a periodically structured porous body is determined based on the structural representation of the periodically structured porous body and the material model, and d) generating a library of the physical properties of the plurality of periodically structured porous bodies based on the physical properties determined for the plurality of periodically structured porous bodies.

In a further aspect of the disclosure, a generation method for generating a control file for additive manufacturing of a physical component comprising or being at least partially made of a periodically structured porous body is presented, wherein the generation method comprises a) providing a selected periodically structured porous body, e.g. as described above, that is adapted for being utilized in an additive manufacturing of the physical component, b) providing a model of the physical component, and c) generating a control file usable for printing the physical component comprising or being at least partially made of the selected structural porous body based on the provided selected porous body and the provided physical component model, and optionally d) providing the control file to a system for manufacturing of the physical component comprising a periodically structured porous body based on the control file.

In another aspect of the disclosure, a computer program product for generating a library of physical properties of periodically structured porous bodies that are utilizable for physical components is presented, wherein the computer program product comprises program code means for causing the apparatus as described above to execute the method as described above.

In another aspect of the disclosure, a computer program product for generating a control file of a physical component comprising or being at least partially made of a periodically structured porous body is presented, wherein the computer program product comprises program code means for causing the generation apparatus as described above to execute a generation method as described above.

In another aspect of the disclosure, the use of any of the apparatuses as described above, any of the systems as described above, and of the methods as described above and/or any of the computer program products as described above for the generation of periodically structured porous bodies for cushioning's for shoes, helmets, seats, rests, matrasses and/or protective gear is presented.

It shall be understood that any of the apparatuses as described above, any of the systems as described above, any of the methods as described above, and any of the computer program products as described above have similar and/or identical preferred embodiments, in particular, as defined in the dependent claims and above described embodiments.

It shall be understood that a preferred embodiment of the present disclosure can also be any combination of the dependent claims or above embodiments with the respective independent claim.

These and other aspects of the disclosure will be apparent from and elucidated with reference to the embodiments described hereinafter.

### BRIEF DESCRIPTION OF THE DRAWINGS

In the following drawings:

FIG. 1 shows schematically and exemplarily an embodiment of a structured porous body printing system,

FIG. 2 shows schematically and exemplarily a flow chart for an embodiment of a method for generating a library of physical properties of a periodically structured porous body,

FIG. 3 shows schematically and exemplarily a possible representation of the library on a user interface,

FIG. 4 shows schematically and exemplarily a workflow in which the periodically structured porous body library is integrated, and

FIG. 5 shows schematically and exemplarily a system for generating a control file and for printing a physical component in the context of a computing system, and

In FIG. 6 shows schematically and exemplarily an exemplary embodiment for determining a target periodically structured porous body.

### DETAILED DESCRIPTION OF EMBODIMENTS

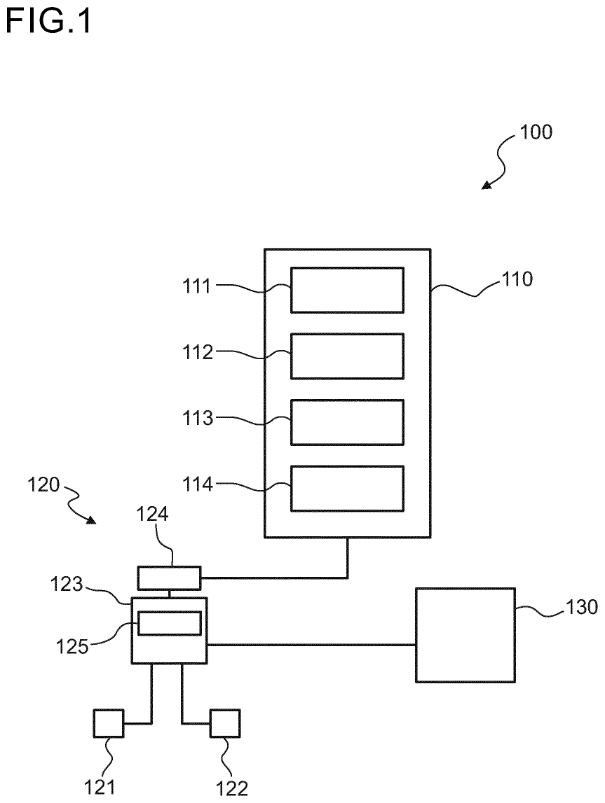

FIG. 1 shows schematically and exemplarily a structured porous body printing system 100 for printing a physical component comprising a periodically structured porous body. The printing system 100 comprises a periodically structured porous body library system 120 and a 3D printer 130. In this exemplarily embodiment, the library system 120 comprises an apparatus 110 for generating a library of physical properties of periodically structured porous bodies and a user interface 123. Further, the library system 120 comprises a library providing unit 124 that is adapted to provide a library generated by the apparatus 110. In some embodiments of the library system 120, the apparatus 110 can also be omitted, wherein in such an embodiment the library providing unit 124 is adapted as storage unit or alternatively connected to a storage unit on which a library generated by the apparatus 110 is already stored.

The apparatus 110 is adapted to generate a library of physical properties of periodically structured porous bodies that can be utilized for the production of physical components. In particular, the apparatus 110 comprises a structured porous body providing unit 111, a material model providing unit 112, a physical property determination unit 113 and a library generation unit 114. Generally, the apparatus 110 can be provided in form of hardware and/or software, for instance, as a standalone device or integrated as part of another hardware and/or software. Moreover, the structured porous body providing unit 111, the material model providing unit 112, the physical property determination unit 113 and the library generation unit 114 can also be provided in form of a general or dedicated hardware and/or software, wherein the different units can also be provided in a delocalized manner, for instance, as part of a cloud on different servers.

The structured porous body providing unit 111 is adapted to provide structural representations of a plurality of periodically structured porous bodies. In a preferred example, the periodically structured porous bodies comprise a periodical lattice structure and the structural representation can comprise structural parameters representing a geometrical shape of the periodical lattice structure. For example, the structural parameter can be indicative of a lattice type, e.g. vintile-, X-, honeycomb-, diamond-lattice, a lattice parameter, a lattice constant, a beam diameter, a unit cell size, an aspect ratio, a beam angle, a wall thickness, etc. Moreover, the structural representations can also comprise structural parameter ranges, for example, a range of beam diameters, e.g. 0.3 to 3 mm, a range of unit cell size, e.g. 1×1×1 until 10×10×10 mm, a range of aspect ratio, e.g. 1:1:1 until 1:10:10 or 1:1:10, and/or any other parameter which can influence the geometry of a structure.

Preferably, the structural representation of a periodically structured porous body allows to generate a digital representation of the respective periodically structured porous body. The structured porous body providing unit 111 can then provide the structural representation of the plurality of periodically structured porous bodies, in particular, to the physical property determination unit 113.

The material model providing unit 112 is adapted to provide a material model, in particular, to the physical property determination unit 113. The material model is generally indicative of a response of a material to one or more external physical influences. Since it is preferred that the periodically structured porous bodies can be produced by the 3D printer 130, it is preferred that the material to which the material model refers is a material that can be utilized in a 3D printing process. Thus, the material of the material model can refer to commonly utilized thermoplastic polymers that are often utilized in 3D printing processes. However, if instead of the here shown 3D printing process another industrial additive production process is preferred for producing a physical component based on the periodically structured porous body, also other materials can be utilized and thus the material model can also refer to these other materials.

The material model can describe the response of the material to physical influences, for instance, based on known physical relationships between the response of the material and a physical influence. In particular, the material model can also be adapted to describe the response of a material comprising a component in form of the periodically structured porous body. Generally, the material model is preferably as sophisticated as needed for the desired determination of the physical property but as simple as possible to reduce the calculation time. Physical relations utilizable in the material model can be found, for instance, based on theoretical considerations but also based on experiments and tests performed with the respective material. For example, material models can be generated out of mechanical test data of printed test specimens of a periodically structured porous body. Such test data can be fitted and included into algorithms which are able to describe the mechanical response of any geometrical shape when influenced by an external event, i.e. physical influence, e.g. a force, an energy, a compression or an impact.

The material model can then be provided in form of mathematical functional relationships between the response and the respective physical influence in form of lookup tables that correlate a respective response with the respective physical influence or in form of more sophisticated numerical simulations that can simulate the response of the material to one or more physical influences. The material model is then provided by the material model providing unit 112 to the physical property determination unit 113.

The physical property determination unit 113 is then adapted to determine physical properties for the plurality of periodically structured porous bodies based on the structural representations provided by the structured porous body providing unit 111 and the material model provided by the material model providing unit 112. Generally, as already described above, the material model refers to a mathematical model which describes the response of a material triggered by an external event, i.e. a physical influence on the material. Accordingly, the material model allows to describe the mechanical response of any physical component comprising this material independent of the geometrical shape, i.e. the structure of the periodically structured porous body. In a preferred embodiment, the physical property determination unit 113 is adapted to generate a digital representation of the geometrical shape of the periodically structured porous body based on the structural representations, e.g. diameter, lattice type, etc. using, for example, a respective program like nTopology, 3-matics Rhino+Grasshopper, NetFab, etc. The digital representation can then be utilized by the physical property determination unit 113 for determining the physical properties.

The determined physical properties can refer to any physical properties that may be interesting for selecting a specific periodically structured porous body from the plurality of periodically structured porous bodies in the context of utilizing the periodically structured porous body for producing a specific physical component. For example, the physical properties can refer to any of a hardness, an E-module, a density, an elongation at break, a compression hardness at x % compression, a stress at x % elongation, a rebound, a flex modulus, a tensile strength, an impact strength, a Poisson's ratio, a tear strength and a temperature capacity. Based on the physical property that shall be determined, the physical property determination unit 113 can be adapted to apply respective mathematical algorithms or functional relationships utilizing the structural representation of the periodically structured porous body and the material model. For example, respective artificial intelligence methods can be utilized that can determine based on the input of the structural representation and optionally of the material model the respective physical property. Generally, in this case, the material model can also be part of the artificial intelligence algorithm, for instance, if the respective artificial intelligence algorithm is trained accordingly. However, the physical property determination unit 113 can also be adapted to utilize other numerical method for determining the physical properties. Preferably, the physical property determination unit 113 is adapted to utilize a finite element analysis (FEA) algorithm for determining the physical property. Generally, in this case it is in many cases possible to utilize commercially available solvers, e.g. ANSYS, ABAQUS, COMSOL, ADINA, LS-DYNA, MARC, etc., using either explicit, implicit or other modeling methods for solving the equations of the respective algorithm. If a finite element analysis is utilized, it is preferred that the physical property determination unit 113 is adapted to generate the digital representation of the periodically structured porous body in the form of a volume mesh using programs such as ANSYS-preprocessor, MeshLab, etc.

The physical property determination unit 113 can be adapted to utilize one of the above described numerical methods, for instance, a finite element analysis method, to simulate the periodically structured porous body in respective test situations that allow the determination of the physical property of the periodically structured porous body based on the response of the periodically structured porous body to the test situation. For example, the physical property determination unit 113 can be adapted to simulate a physical event effected on the periodically structured porous body based on the structural representation of the periodically structured porous body and the material model and to determine from the simulated response of the periodically structured porous body to the physical event the physical property. Preferably, such a simulated physical event refers generally to a simulated physical testing procedure that provides a response that is indicative of the respective physical property. In particular, suitable are physical testing procedures that are based on testing procedures described in an industrial norm. For example, the physical properties and their correlated tests can be described in norms from ISO or ASTM, e.g. Tensile ISO527, Compression hardness, Shore Hardness, Density, etc. Moreover, the industrial norm can also refer to application specific standardized tests as e.g. impact tests for NFL Helmets. Generally, the tests can refer to any specific test which gives as result a mechanical response from which physical properties can be inferred which the end user is interested in.

Utilizing standardized tests from industrial norms allows to determine the physical properties in a normalized way such that they can easily be compared not only with each other but also with physical properties determined in a real testing procedure according to the industrial norm. Moreover, in particular if artificial intelligence methods shall be trained for determining the physical properties, testing procedures described in industrial norms have the advantage that a plurality of results from such testing procedures are available and can be used for training the artificial intelligence and for testing the output of the artificial intelligence after the training.

The results of the physical property determination unit 113, in particular, the determined physical properties and the plurality of periodically structured porous bodies, are then provided to the library generation unit 114.

The library generation unit 114 is then adapted to generate a library of the physical properties of the plurality of periodically structured porous bodies based on the determined physical properties. For example, the library generation unit 114 can be adapted to store the physical properties in an interrelated manner with the respective periodically structured porous bodies for which they have been determined. For example, the library generation unit 114 can generate a 2D matrix in which for each periodically structured porous body of the plurality of periodically structured porous bodies the respective determined physical properties are stored. Moreover, if additional dependencies of the physical properties are known, for instance, temperature dependencies that have been taken into account when determining the physical properties, also these additional dependencies can be stored in an interrelated manner with the physical properties and the periodically structured porous bodies. For example, in this case, the library generation unit 114 can be adapted to generate a 3D or even more dimensional matrix that represents also the additional dependencies, for instance, the temperature dependencies. The respective generated library of the physical properties is then provided to the library providing unit 124 of the library system 120.

The library providing unit 124 of the periodically structured porous body library system 120 is adapted to provide the library of the physical properties, in particular, to the user interface 123. The user interface 123 is adapted to allow for an interaction of a user with the provided library of physical properties. For example, the user interface 123 can comprise a display unit 121 that can be, for instance, a monitor or any other kind of hardware that allows to display information to the user, and an input unit 122 that can refer, for instance, to a mouse, a keyboard, a touchscreen, etc., and allows a user to provide input to the user interface 123.

In particular, the user interface 123 can be adapted to allow for a searching of the provided library. In this case, a user can, by utilizing the input unit 122, input one or more desired characteristics indicative of at least one physical property of a periodically structured porous body. For example, the user can input a specific hardness or hardness range that is desired for a specific physical component. The user interface 123 can then comprise a search unit 125 that is adapted to search the library based on the input of the desired characteristics. In particular, the search unit 125 can be adapted to infer from the input of the desired characteristics the respective physical properties and search the library for periodically structured porous bodies with the respective physical properties. The user interface 123 can then be adapted to provide the found periodically structured porous bodies with the respective desired characteristics as output to the user by utilizing, for instance, the display unit 121.

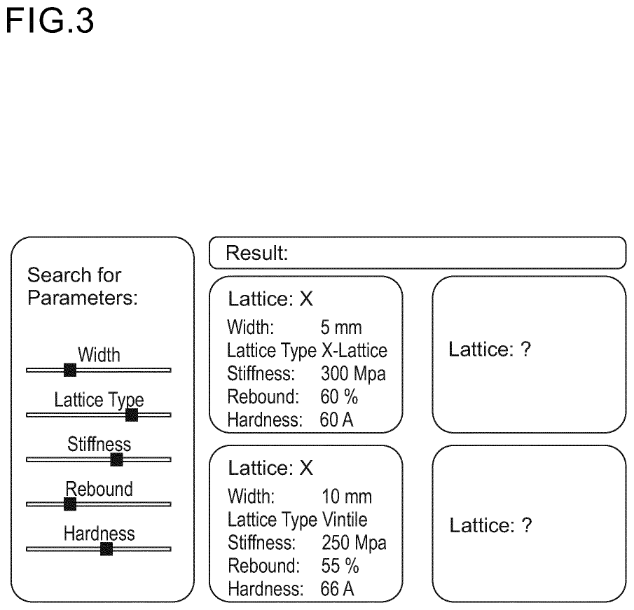

FIG. 3 shows a possible example of such an output of the found periodically structured porous bodies on a display unit 121. In this example, a user has searched the library for periodically structured porous bodies utilizing sliding bars at the left side to indicate different desired characteristics of the periodically structured porous body. Based on these characteristics the search unit 125 has determined physical properties that are assigned to these characteristics, for instance, by a predefined assignment. The result of the search is then provided to the user on the right side of the exemplary output on the display unit 121 as shown in FIG. 3. In this example, two periodically structured porous bodies fulfill the search terms, i.e. have the desired physical properties and other characteristics. These structured porous bodies are thus presented, for instance, together with structural parameters characterizing the respective periodically structured porous bodies. Further, additional information that can be of interest to a user can be provided, for instance, other physical properties or characteristics. Optionally, also a representative image of the periodically structured porous body can be provided, for example, in form of one cell of the structured porous body.

If more than one periodically structured porous body has been found, the user can then select one of the found periodically structured porous bodies and, for instance, decide that the respective physical component shall be 3D printed in form of a respective physical component. In this case, the user interface 123 is adapted to provide as output after the interaction of the user with the library a digital representation of the desired periodically structured porous body as part of the physical component in a data format that is adapted to being utilized by the 3D printer 130. This output can then be sent to the 3D printer 130 for printing the physical component comprising the desired periodically structured porous body.

Generally, a plurality of different user interfaces can be provided with respect to different applications of the system. For example, similar to the above described example, the user interface 123 can be an interactive user interface in which a user can define as characteristics requirements for properties, e.g. shore hardness, density and compression hardness. The user interface 123 can then search the library and suggests all periodically structured porous bodies which fulfill those requirements and optionally suggests further options to filter the results by additional characteristics. In an advanced version the user interface 123 can be adapted such that a user can upload a physical component geometry or shell and the user interface 123 is then adapted to automatically fill the respective physical component geometry or shell at least partially with a chosen periodically structured porous body. Additionally or alternatively, the user interface 123 can be adapted to provide a manufacturing interface. Such a manufacturing interface can be adapted, for instance, such that a scan of a manufactured periodically structured porous body is provided as input to the user interface 123, wherein the user interface 123 is then adapted to search the library for the manufactured periodically structured porous body in order to provide a user with the expected mechanical properties of the manufactured periodically structured porous body. A user can then decide whether the expected physical properties are within an acceptable tolerance or not.

In a preferred example, the user interface 123 refers to or comprises a back-end interface that is adapted for a specific application of the library. For example, the user interface 123 can be adapted to be provided, for example with a scan, a pressure map or any other measurement of a human body part. The user interface 123 can then be adapted to use this input together with the library to design a customized part of a personalized product. For instance, the input can refer to a scan and pressure map of the feet of a customer. The user interface can then be adapted to calculate, based on the input, a specific hardness at any location of a sole or insole. In order to generate the digital representation of an individualized sole or insole, the user interface 123 can be adapted to access the library and search for a periodically structured porous body comprising the respective determined specific hardness at any location of the sole or insole. Using this information, the user interface 123 can then be adapted to generate the individualized sole or insole and forward it to the 3D printer 130 for manufacturing.

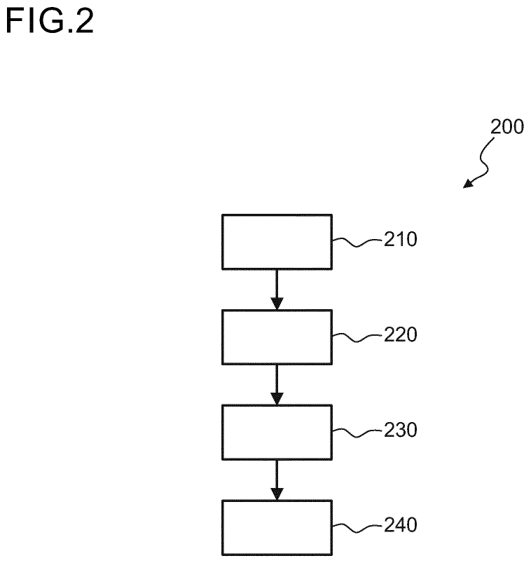

FIG. 2 shows schematically and exemplarily a flow chart of a method for generating a library of physical properties of periodically structured porous bodies. The method 200 comprises a step 210 of providing a structural representation for a plurality of periodically structured porous bodies. In a step 220, a material model is provided, wherein the material model is indicative of a response of a material to one or more external physical influences. Generally, the steps 210 and 220 can be performed in any sequence or even at the same time. In a further step 230, physical properties for the plurality of periodically structured porous bodies are determined, wherein a physical property for a periodically structured porous body is determined based on the structural representation of the periodically structured porous body and the material model. In the last step 240, finally a library of the physical properties of the plurality of periodically structured porous bodies is generated based on the determined physical properties. Generally, the principles described with respect to the system described in FIG. 1 can also be applied to the method described with respect to FIG. 2.

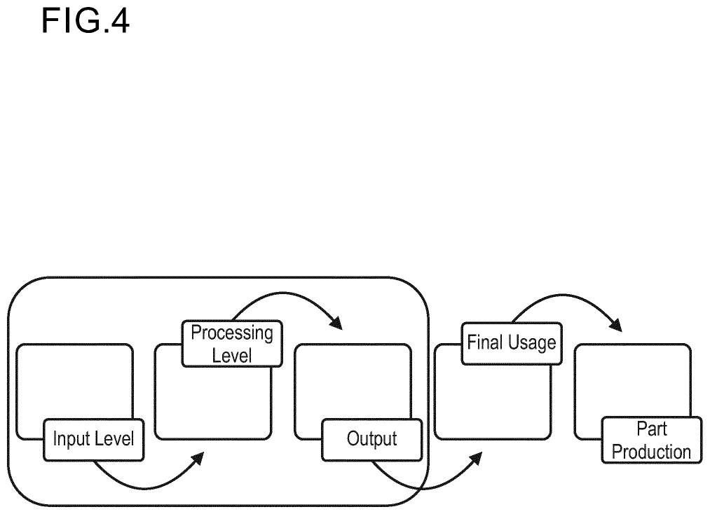

FIG. 4 shows another schematic view of an exemplary flowchart of an embodiment of the invention. In this example, different processing levels can be defined. A first processing level refers to the input level. The input level can be regarded as comprising the input provided to the apparatus for generating the library. For example, the input can refer to the structural representations of the periodically structured porous bodies and the material model, as described above, and the structured porous body providing unit 111 and the material model providing unit 112 can be regarded as part of the input level. Generally, the input level can refer to processes where input is retrieved from a data storage or is directly provided, for instance, via an input unit by the user. In the processing level the input provided in the input level is processed, for instance, to generate the physical properties of the periodically structured porous bodies. For example, the physical property determination unit 113, as described above, can be regarded as being part of the processing level. At the output level the output of the apparatus is generated. For example, the generation of the library and the library generation unit 14, as described above can be regarded as belonging to the output level. Accordingly, the input level, the processing level and the output level refer to functions of the generation of the physical property library as provided by the apparatus 110 exemplarily described with respect to FIG. 1.

Optionally, in addition to the functions for generating the physical property library, further levels can be provided. For example, a final usage level can be provided in form of a user interface allowing for an interaction with the output of the output level, in particular, with the library. Preferably, the final usage level comprises functions that are specifically adapted to an application of the library, for instance, user interfaces are provided at this level allowing for a specific search based on characteristics of specific physical components. Further, functions can optionally be provided in a part production level. This level can comprise functions that support the production of the physical component comprising a selected periodically structured porous body. For example, functions that allow to provide a physical component with the selected structure in a data format, for example, as control file that can be utilized by a 3D printer can be part of this level. Also the 3D printer and its infrastructure can be part of this level.

Generally, a system and method as described above, allows to generate a large data set of material properties correlated to specific periodically structured porous bodies in form of a searchable library. Moreover, to allow for the generation of the library printing and testing procedures of different periodically structured porous body specimens to build up a data set of material properties can be reduced or even completely avoided. Thus, a user is given a fast and easy access to a broad range of mechanical properties possible with a 3D printing material by using periodically structured porous bodies.

Some more detailed examples of the invention will be described in the following. In a preferred embodiment, the above described system and method are adapted to be utilized in an application of supporting a user to replace traditional material with a periodically structured porous body. End users are often interested to 3D print a physical component comprising a, preferably, flexible, material which mimics the behavior of a physical component produced from a traditional material/foam, e.g. PU- or E-TPU-foam, PA6, etc. In such a case, the mechanical properties of the traditionally used material/foam in the physical component such as shore hardness, density, flex-modulus or compression hardness are known. Thus, the user interface can be adapted such that a user can search the library for these known desired properties. Based on the result of the search, the user interface can be adapted to allow a user to select one of the found periodically structured porous bodies. Moreover, the user interface can also be adapted to use the found and/or selected periodically structured porous body with the desired properties closest to the material/foam that shall be replaced to fill a volume of the physical component with the respective periodically structured porous body and print it using a 3D printing material, e.g. Ultrasint TPU01. Thus, in this application the system allows a user a fast and easy access to switch from traditional material/foam parts to 3D printed parts enabling to mimic many materials/foams with a single 3D printing material.

In another preferred example, the system and method as described above can additionally or alternatively be adapted to be utilized for physical component individualization. Designer of consumer parts, e.g. shoes, helmets, protective gear, etc. are often looking, with the new possibilities of 3D printing, into individualization of their products. If a designer knows the mechanical properties needed for a specific customer, e.g. depending on a weight or pressure map scan of a foot, the user interface can be adapted to be provided with these mechanical properties as characteristics and to search the library for respective periodically structured porous bodies with the corresponding physical properties. This allows to fast choose the right periodically structured porous body for a physical component for one specific customer. In this example, it is preferred that the user interface comprises an algorithm that allows to infer from the mechanical properties measurable from a respective customer the corresponding physical properties. Moreover, the user interface can also be adapted, in a case in which the mechanical properties are different for different parts of the physical component, to provide a structural description of the physical component comprising different periodically structured porous bodies for different locations of the physical component. For example, measuring a pressure map of a foot of a customer can mean that specific mechanical properties, e.g. hardness, at different areas/locations of, for example, an insole/sole, are needed. The user interface can then be adapted to automatically design the insole from the pressure map using the library to choose the right periodically structured porous body at every location of the sole/insole.

In another preferred example, the system and method as described above can additionally or alternatively be adapted to be utilized to support a user in finding a physical component that fulfills a specific norm. Often physical components have to fulfill specific norms, e.g. motorbike protective gear needs to fulfill specific impact requirements as described in EN1621. Thus, depending on the intended application the physical property determination unit can be adapted to determine as physical property whether or not a respective norm is fulfilled and/or the physical properties indicated by the norm, e.g. EN1621. Thus, the results of the respective test defined by the norm are included as physical properties in the library. Accordingly, the user interface can be adapted to allow a user to search for periodically structured porous bodies that fulfill a respective norm. This allows to find a physical component which fulfills the requirements of a norm much easier and that will probably pass the certification process using the periodically structured porous body.

In another preferred example, the system and method as described above can additionally or alternatively be adapted to be utilized for determining manufacturing tolerance acceptance levels. If a part must fulfill specific requirements, e.g. as described in an industrial norm, the library can be used to identify the accepted or allowed manufacturing tolerances. Preferably, in this application the user interface is adapted to provide to a user all periodically structured porous bodies that fulfill respective desired physical properties. Based on the result, the user can infer which structural parameter ranges fulfill the desired physical properties. Also the user interface can be adapted to automatically provide the ranges of the structural parameters of structured porous bodies fulfilling the desired physical properties to the user as manufacturing tolerances. For example, the user interface can be adapted to identify how big the variation of a beam diameter of a periodically structured porous body can be while still fulfilling the needed physical properties. Such determined tolerances can then be used in a quality control process to define the diameters variations which will pass or are rejected by the quality control of the respective component.

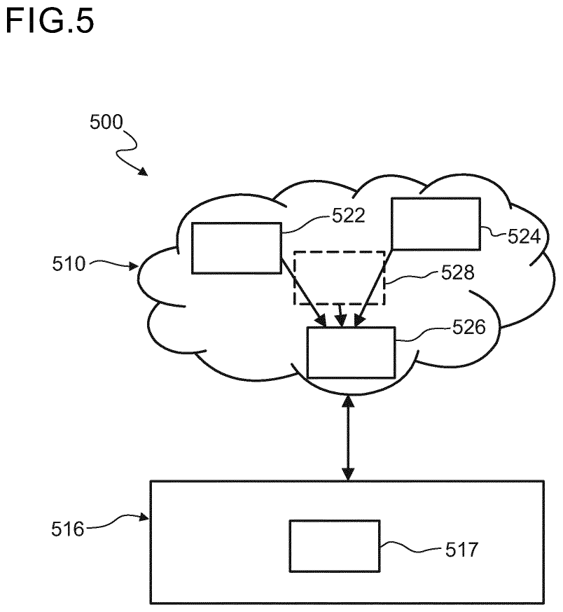

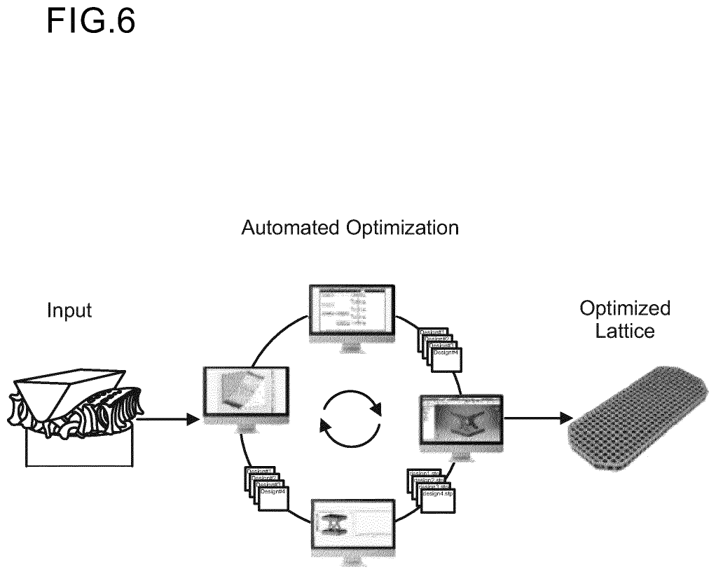

FIG. 5 shows schematically and exemplarily a system 500 for generating a control file and for manufacturing a physical component by using additive manufacturing in the context of a computing system.

Computing systems can take a wide variety of forms. Computing systems may, for example, be handheld devices, appliances, laptop computers, desktop computers, mainframes, distributed computing systems, data centers, or even devices that have not conventionally been considered as computing system, such as machines for additive manufacturing or 3D printers. In this description and in the claims, the term “computing system” is defined broadly as including any device or system (or a combination thereof) that includes at least one physical and tangible processor, and a physical and tangible memory capable of storing thereon data or of having thereon computer-executable instructions that may be executed by a processor. The memory may take any form and may depend on the nature and form of the computing system. A computing system may be distributed over a network environment and may include multiple constituent computing sub-systems.

As illustrated in FIG. 5 the system 510 for generating a control file may include a cloud infrastructure with at least one hardware processing unit and memory. The system 516 for manufacturing a physical component by using additive manufacturing may include a 3D printer 517 with at least one hardware processing unit and memory.

The system 510 for generating a control file may comprise a structured porous body providing unit 522 for providing at least one structural representation for one or more periodically structured porous bodies and a material model providing unit 524 for providing a material model, wherein the material model is indicative of a response of a material to one or more external physical influences, for example, in accordance with the exemplary embodiments as described with respect to FIG. 1. Such providing units 522, 524 may refer to a memory of the computing system that can be accessed by the processing unit or an interface to a processing unit that may receive data from any other component of the computing system. An interface may be a communication interface, e.g. in case of a distributed network, an Application Programming Interface (API) or any method or function call implemented in computer-executable instructions.

The at least one structural representation and the material model may be provided to the physical property determination unit 526. The physical property determination unit 526 may be a processing unit. In some instances, multiple structural representations and material models may be provided. The physical property determination unit 526 may be configured to determine at least one physical property for one or more periodically structured porous bodies, wherein a physical property for a periodically structured porous body is determined based on the structural representation of the periodically structured porous body and the material model, for instance, in accordance with the principles described with respect to FIG. 1. If multiple structural representations and material models are provided, multiple physical properties may be determined.

If multiple physical properties are determined, a selection unit 528 may be configured to select one periodically structured porous body based on the physical properties, one or more structural parameters of a periodically structured porous body and/or the physical component to be manufactured, e.g. its shape or the desired or preferred material. For instance, a desired characteristics providing unit may provide desired characteristics indicative of a physical property of a periodically structured porous body to the selection unit 528. The selection unit 528 may be adapted to select one or more structured porous bodies comprising one or more of the desired characteristics based on the determined physical properties, the physical component to be manufactured and/or the structural parameters. Based on such selection the selection unit 528 may provide the selected periodically structured porous bodies. If more than one periodically structured porous body is selected, such selection may be displayed to a user for further selection.

The selected periodically structured porous body including a structural representation and/or physical properties may be provided to a control file generator 526 for generating a control file usable for manufacturing a physical component partially made of the periodically structural porous body. Such control file generator 526 may be configured to generate a three-dimensional representation of the physical component including the periodically structured porous body. Here, the periodically structured porous body is a substructure embedded into the three-dimensional shape of the physical component. Based on the three-dimensional representation of the physical component including the periodically structured porous body, the control file generator 526 may further be configured to determine a manufacturing path for successively applying a plurality of material layers. The control file generator 526 may be configured to generate further control parameters for the manufacturing process such as temperature, material selection or other control parameters.

In case of a distributed computing system, the control file generator 526 may comprise a communication interface for providing the control file to a communication interface of the system 516 for manufacturing a physical component by using additive manufacturing. The system 516 for manufacturing a physical component includes, in this example, a 3D printer 517 configured to additively manufacture the physical component based on the provided control file.

In another implementation a system 500 may comprise as alternative to the selection unit 528 a periodically structured porous body library system with a user interface. The user interface may be adapted to provide as output, after an interaction of the user with the library system, a desired periodically structured porous body that is selected for being utilized in the additive manufacturing process of the physical component. Such selected periodically structured porous body may be provided to the control file generator 526 for generating a control file usable for additive manufacturing the physical component at least partially made of the selected periodically structured porous body as described above. The control file may be provided to the system 516 for manufacturing a physical component by using additive manufacturing that is adapted to utilize the control file for printing the physical component.

In yet another implementation, the periodically structured porous body manufacturing system 500 for manufacturing a physical component comprising a periodically structured porous body may comprise the periodically structured porous body library system as described above and the selection unit 528 for selecting a desired periodically structured porous body based on the desired physical property. The selected periodically structured porous body may be provided to the control file generator 526 for generating a control file usable for printing a physical component at least partially made of selected periodically structural porous bodies The control file may be provided to the system 516 for manufacturing a physical component by using additive manufacturing that is adapted to utilize the control file for printing the physical component.

In FIG. 6 an exemplary embodiment for determining a target periodically structured porous body, preferably, based on a generated library, is described in more detail in the following. Generally, it is preferred that in this embodiment the structural representation of a periodically structured porous body is based on structural parameters of the periodically structured porous body that can be varied and modified when searching for a target periodically structured porous body. In particular, in this parametric approach it is preferred to choose and modify the structural parameters of a periodically structured porous body that have been determined to be the most influential in achieving a desired result, i.e. of influencing a target physical property of a periodically structured porous body.

In this example, the process starts with providing a structural representation of a periodically structured porous body comprising, preferably, a computer-aided design (CAD), and further with providing specific requirements that the structure must fulfill referring, for instance, to the target physical properties but also to other constraints, for instance, manufacturing constraints. For example, the specific requirements can refer to a size, shape, and density of the target periodically structured porous body, and/or to material properties such as energy to be absorbed at impact, required rebound, required stiffness at certain compression levels, and compaction grade, and/or to a desired mechanical response like a force-displacement behavior. Optionally, lattice types that are considered as providing a good fit based on the defined specific requirements can also be selected and provided, and further based on the selected lattice types the structural parameters like cell shape, size beam diameter, orientation, etc. can be provided as necessary for a respective lattice type, also as part of the structural representation. Moreover, in a preferred embodiment, further simulation tests like a standard compression, shore hardness, rebound, impact or even tests according to a norm (e.g. ISO 1621) can be defined based on the target application's performance requirements, i.e. the provided target physical properties.

Based on the above provided structural representation comprising optionally the selected lattice types and the selected structural parameters various simulations utilizing, for example, finite element simulations or machine learning algorithms as described above can be run and rerun continuously on the different lattice types and structural parameters until a landscape of physical properties, i.e. a library, is generated.

In particular, the determination of the physical property of the periodically structured porous bodies of the provided structural representations can comprise firstly generating a data driven lattice design, i.e. a digital representation of a respective lattice, corresponding to a respective given structural parameter set, for instance, based on the structural representation. In a next step, the generated digital representation of the respective lattice can be meshed in accordance with quality requirements of a Finite Element Method (FEM). The respective FEM can then be used for preparing a simulation of the respective lattice using, for example, predefined templates, e.g., specific norm tests, and respective material models. Then the simulation is performed for the respective lattice. The results of the simulation together with the results of the simulation of the other lattices of the provided structural representations can then be utilized to build the landscape of physical properties.

Generally, an automated workflow as described above enables the use of mathematical optimizers directly, for instance, on digital twins of actual mechanical tests provided as part of the simulation, without the approximation of homogenization-based approaches, or reducing manual iterations. Moreover, in a preferred embodiment the generation of a lattice library can also be omitted in an optimization process, by directly comparing the resulting physical properties of the simulation with target physical properties and by performing further simulations of the provided structural representations only when the resulting physical properties do not fulfil respective predetermined criteria, for instance, lie within a predetermined range around the target physical properties. In this case simulations of an amended periodically structured porous body can be iteratively performed if the predetermined criterion is not fulfilled, wherein the amended periodically structured porous body can be selected from the provided structural representations or can be provided by amending, for instance, structural parameters of a previously simulated periodically structured porous body. Generally, the iteration can be performed until the target criterion is fulfilled or until an abortion criterion is reached indicated that the optimization is not possible with the provided constrains.

Other variations to the disclosed embodiments can be understood and effected by those skilled in the art in practicing the claimed invention, from a study of the drawings, the disclosure, and the appended claims.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the providing of the structural representation, the providing of a material model, the determining of the physical properties, the generating of the library, etc. performed by one or several units or devices can be performed by any other number of units or devices. These procedures can be implemented as program code means of a computer program and/or as dedicated hardware.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any units described herein may be processing units that are part of a computing system. Processing units may include a general-purpose processor and may also include a field programmable gate array (FPGA), an application specific integrated circuit (ASIC), or any other specialized circuit. Any memory may be a physical system memory, which may be volatile, non-volatile, or some combination of the two. The term “memory” may include any computer-readable storage media such as a non-volatile mass storage. If the computing system is distributed, the processing and/or memory capability may be distributed as well. The computing system may include multiple structures as “executable components”. The term “executable component” is a structure well understood in the field of computing as being a structure that can be software, hardware, or a combination thereof. For instance, when implemented in software, one of ordinary skill in the art would understand that the structure of an executable component may include software objects, routines, methods, and so forth, that may be executed on the computing system. This may include both an executable component in the heap of a computing system, or on computer-readable storage media. The structure of the executable component may exist on a computer-readable medium such that, when interpreted by one or more processors of a computing system, e.g., by a processor thread, the computing system is caused to perform a function. Such structure may be computer readable directly by the processors, for instance, as is the case if the executable component were binary, or it may be structured to be interpretable and/or compiled, for instance, whether in a single stage or in multiple stages, so as to generate such binary that is directly interpretable by the processors. In other instances, structures may be hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. Any embodiments herein are described with reference to acts that are performed by one or more processing units of the computing system. If such acts are implemented in software, one or more processors direct the operation of the computing system in response to having executed computer-executable instructions that constitute an executable component. Computing system may also contain communication channels that allow the computing system to communicate with other computing systems over, for example, network. A “network” is defined as one or more data links that enable the transport of electronic data between computing systems and/or modules and/or other electronic devices. When information is transferred or provided over a network or another communications connection, for example, either hardwired, wireless, or a combination of hardwired or wireless, to a computing system, the computing system properly views the connection as a transmission medium. Transmission media can include a network and/or data links which can be used to carry desired program code means in the form of computer-executable instructions or data structures and which can be accessed by a general-purpose or special-purpose computing system or combinations. While not all computing systems require a user interface, in some embodiments, the computing system includes a user interface system for use in interfacing with a user. User interfaces act as input or output mechanism to users for instance via displays.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables, such as glasses, and the like. The invention may also be practiced in distributed system environments where local and remote computing system, which are linked, for example, either by hardwired data links, wireless data links, or by a combination of hardwired and wireless data links, through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources, e.g., networks, servers, storage, applications, and services. The definition of “cloud computing” is not limited to any of the other numerous advantages that can be obtained from such a model when deployed. The computing systems of the figures include various components or functional blocks that may implement the various embodiments disclosed herein as explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems shown in the figures may include more or less than the components illustrated in the figures and some of the components may be combined as circumstances warrant.

Any reference signs in the claims should not be construed as limiting the scope.

In an aspect the invention refers to an apparatus for generating a library of physical properties of periodically structured porous bodies that are utilizable for physical components, wherein the apparatus comprises a) a structured porous body providing unit for providing structural representations for a plurality of periodically structured porous bodies, wherein a structural representation is indicative of a structure of a periodically structured porous body, b) a material model providing unit for providing a material model, wherein the material model is indicative of a response of a material to one or more external physical influences, c) a physical property determination unit for determining physical properties for the plurality of periodically structured porous bodies, wherein a physical property for a periodically structured porous body is determined based on the structural representation of the periodically structured porous body and the material model, and d) a library generation unit for generating a library of the physical properties of the plurality of periodically structured porous bodies based on the physical properties determined for the plurality of periodically structured porous bodies.

In an embodiment one of the apparatus, the material model is based on a material utilizable in an additive manufacturing process.

In an embodiment two of the apparatus according to all previous embodiments, the physical property determination unit is adapted, for determining a physical property of a periodically structured porous body, to simulate a physical event effected on the periodically structured porous body and to determine from a simulated response of the periodically structured porous body to the physical event the physical property.

In an embodiment three of the apparatus according to embodiment two, the physical property determination unit is adapted to utilize a finite element method for simulating the physical event and the response of the periodically structured porous body.

In an embodiment four of the apparatus according to any of embodiment two and three, the simulated physical event is part of a simulated physical testing procedure that provides a response indicative of a predetermined physical property.

In an embodiment five of the apparatus according to embodiment four, the simulated physical testing procedure is based on a testing procedure described in an industrial norm.

In an embodiment six of the apparatus according to all previous embodiments, the structural representation of a periodically structured porous body comprises structural parameters representing a geometrical shape of the periodically structured porous body, wherein the structural parameters are indicative of at least one of a lattice type, a lattice parameter, a lattice constant, a beam diameter, a unit cell size, an aspect ratio, a beam angle, and a wall thickness.

In an embodiment seven of the apparatus according to embodiment six, the physical property determination unit is further adapted to convert the structural parameters into a digital representation of the respective periodically structured porous body and to determine the physical properties based on the digital representation of the periodically structured porous body.

In an embodiment eight of the apparatus according to all previous embodiments, the determined physical properties of a periodically structured porous body refer to at least one of a hardness, an E-module, a density, an elongation at break, a compression stiffness at x % compression, a stress at x % elongation, a rebound, a shore hardness, a flex-modulus, a tensile strength, an impact strength, a Poisson's ratio, a tear strength, and a temperature capacity.

In an embodiment nine of the apparatus according to all previous embodiments, the library comprises a 2D matrix data structure in which each determined physical property is correlated to the respective periodically structured porous body.

In an embodiment ten of the apparatus according to all previous embodiments, wherein the library generation unit is further adapted to utilize one or more of the determined physical properties of a periodically structured porous body to generate a homogeneous material model referring to a physical model of a homogeneous material with the same physical properties as the periodically structured porous body, wherein the library generation unit can further be adapted to provide the homogeneous material model for a periodically structured porous body as part of the library.

In a further aspect the invention refers to a periodically structured porous body library system comprising a) a library providing unit for providing a library of physical properties of periodically structured porous bodies generated by the apparatus according to all previous embodiments, and b) a user interface adapted to allow for an interaction of a user with the library.

In an embodiment one of the library system, the user interface is adapted to allow for a search of the library by providing an input unit adapted to receive an input of a user referring to one or more desired characteristics indicative of a physical property of a periodically structured porous body and a search unit adapted for searching the library for a periodically structured porous body comprising one or more of the desired characteristics based on the determined physical properties and/or the structural parameters and to provide the found periodically structured porous body as output to the user.

In an embodiment two of the library system according to all previous embodiments, the user interface is further adapted to allow to search the library additionally with respect to a manufacturing tolerance of the desired characteristics, wherein the search unit is further adapted to utilize the library to provide a periodically structured porous body together with structural parameters comprising tolerances that fulfill the desired characteristics within the manufacturing tolerances.

In a further aspect the invention refers to a generation system for generating a control file for additive manufacturing of a physical component comprising or being at least partially made of a periodically structured porous body is presented, wherein the generation system comprises a) a periodically structured porous body library system according to all previous embodiments adapted to provide a structured porous body that is adapted for being utilized in an additive manufacturing of the physical component, b) a physical component model providing unit for providing a model of the physical component, and c) a control file generator for generating a control file usable for an additive manufacturing of the physical component comprising or being at least partially made of the selected structural porous body based on the provided selected porous body and the provided physical component model.

In a further aspect the invention refers to a method for generating a library of physical properties of periodically structured porous bodies that are utilizable for physical components, wherein the method comprises a) providing a structural representation for a plurality of periodically structured porous bodies, b) providing a material model, wherein the material model is indicative of a response of a material to one or more external physical influences, c) determining physical properties for the plurality of periodically structured porous bodies, wherein a physical property for a periodically structured porous body is determined based on the structural representation of the periodically structured porous body and the material model, and d) generating a library of the physical properties of the plurality of periodically structured porous bodies based on the physical properties determined for the plurality of periodically structured porous bodies.

In a further aspect the invention refers to a computer program product for generating a library of physical properties of periodically structured porous bodies that are utilizable for physical components, wherein the computer program product comprises program code means for causing the apparatus according to all previous embodiments to execute the method according to all previous embodiments.

In a further aspect the invention refers to the use of an apparatus according to all previous embodiments, a method according to all previous embodiments and/or a computer program product according to all previous embodiments for the manufacturing of periodically structured porous bodies for cushioning's for shoes, helmets, seats, rests, matrasses and/or protective gear.

In an aspect the invention refers to a generation apparatus for generating a control file for additive manufacturing of a physical component comprising or being at least partially made of a structural porous body, wherein the apparatus comprises a) a structured porous body providing unit for providing a structural representation for a periodically structured porous body, wherein the structural representation is indicative of a structure of the periodically structured porous body, b) a material model providing unit for providing a material model, wherein the material model is indicative of a response of a material to one or more external physical influences, c) a physical property determination unit for determining physical properties for the periodically structured porous body, wherein a physical property for the periodically structured porous body is determined based on the structural representation of the periodically structured porous body and the material model, and d) a control file generator for generating a control file usable for manufacturing the physical component comprising or being at least partially made of the structural porous body.

In an embodiment one of the generation apparatus, the apparatus further comprises a communication interface for providing the control file to a 3D printer interface.

In an embodiment two of the generation apparatus according to all previous embodiments, the material model is based on a material utilizable in an additive manufacturing process.

In an embodiment three of the generation apparatus according to all previous embodiments, the physical property determination unit is adapted, for determining a physical property of a periodically structured porous body, to simulate a physical event effected on the periodically structured porous body and to determine from a simulated response of the periodically structured porous body to the physical event the physical property.

In an embodiment four of the generation apparatus according to embodiment three, the physical property determination unit is adapted to utilize a finite element method for simulating the physical event and the response of the periodically structured porous body.

In an embodiment five of the generation apparatus according to any of embodiments three and four, the simulated physical event is part of a simulated physical testing procedure that provides a response indicative of a predetermined physical property.

In an embodiment six of the generation apparatus according to embodiment five, the simulated physical testing procedure is based on a testing procedure described in an industrial norm.

In an embodiment seven of the generation apparatus according to all previous embodiments, the structural representation of a periodically structured porous body comprises structural parameters representing a geometrical shape of the periodically structured porous body, wherein the structural parameters are indicative of at least one of a lattice type, a lattice parameter, a lattice constant, a beam diameter, a unit cell size, an aspect ratio, a beam angle, and a wall thickness.

In an embodiment eight of the generation apparatus according to embodiment seven, the physical property determination unit is further adapted to convert the structural parameters into a digital representation of the respective periodically structured porous body and to determine the physical properties based on the digital representation of the periodically structured porous body.

In an embodiment nine of the generation apparatus according to all previous embodiments, the determined physical properties of a periodically structured porous body refer to at least one of a hardness, an E-module, a density, an elongation at break, a compression stiffness at x % compression, a stress at x % elongation, a rebound, a shore hardness, a flex-modulus, a tensile strength, an impact strength, a Poisson's ratio, a tear strength, and a temperature capacity.

In an embodiment ten of the generation apparatus according to all previous embodiments the generation apparatus further comprises a library generation unit for generating a library of physical properties of a plurality of periodically structured porous bodies based on the physical properties determined for the periodically structured porous body.

In an embodiment eleven of the generation apparatus according to embodiment ten, the control file generator is adapted to generate the control file based on the library.

In an embodiment twelve of the generation apparatus according to all previous embodiments, the generation apparatus further comprises an optimization unit for optimizing a physical component, wherein the optimization unit is adapted to i) receive a target physical property of a target structured porous body, ii) compare the target physical property with the physical property determined for a periodically structured porous body by the physical property determination unit, and iii) decide, based on the comparison, whether to a) generate an amended structural representation of an amended periodically structured porous body and/or an amended material model, repeating the determination of the physical property by the physical property determination unit, and the comparison or b) select the periodically structured porous body as the target periodically structured porous body for which the control file generator generates the control file.

In an embodiment thirteen of the apparatus according to embodiment twelve, the optimization unit is adapted to generate a plurality of amended structural representation of an amended periodically structured porous body and to initiate a determination of a physical property for all generated periodically structured porous bodies by the physical property determination unit to generate a library of periodically structured porous bodies from which a periodically structured porous body fulfilling the target physical property is selected and a respective control file generated by the control file generation unit.

In a further aspect the invention refers to an interface system for generating a control file for additive manufacturing of a physical component comprising or being at least partially made of a structural porous body, wherein the interface system comprises a) a generation apparatus according to all previous embodiments, and b) an interface unit configured to provide an interface with the apparatus.

In a further aspect the invention refers to a generation method for generating a control file for additive manufacturing of a physical component comprising or being at least partially made of a structural porous body, wherein the method comprises a) providing a structural representation for a periodically structured porous body, wherein the structural representation is indicative of a structure of the periodically structured porous body, b) providing a material model, wherein the material model is indicative of a response of a material to one or more external physical influences, c) determining physical properties for the periodically structured porous body, wherein a physical property for the periodically structured porous body is determined based on the structural representation of the periodically structured porous body and the material model, and d) generating a control file usable for manufacturing the physical component comprising or being at least partially made of the structural porous body.

In a further aspect the invention refers to a computer program product for generating a control file for additive manufacturing, wherein the computer program product comprises program code means for causing the generation apparatus according to all previous embodiments to execute the generation method according to all previous embodiments.

In a further aspect the invention refers to the use of an generation apparatus according to all previous embodiments, a generation method according to all previous embodiments and/or a computer program product according to all previous embodiments for the manufacturing of periodically structured porous bodies for cushioning's for shoes, helmets, seats, rests, matrasses and/or protective gear.

1.-18. (canceled)

19. A generation apparatus for generating a control file for additive manufacturing of a physical component comprising or being at least partially made of a structural porous body, wherein the apparatus comprises:
a structured porous body providing unit for providing a structural representation for a periodically structured porous body, wherein the structural representation is indicative of a structure of the periodically structured porous body,
a material model providing unit for providing a material model, wherein the material model is indicative of a response of a material to one or more external physical influences,
a physical property determination unit for determining physical properties for the periodically structured porous body, wherein a physical property for the periodically structured porous body is determined based on the structural representation of the periodically structured porous body and the material model, and
a control file generator for generating a control file usable for manufacturing the physical component comprising or being at least partially made of the structural porous body.

20. The apparatus according to claim 19, wherein the apparatus further comprises a communication interface for providing the control file to a 3D printer interface.

21. The apparatus according to claim 19, wherein the material model is based on a material utilizable in an additive manufacturing process.

22. The apparatus according to claim 19, wherein the physical property determination unit (113, 526) is adapted, for determining a physical property of a periodically structured porous body, to simulate a physical event effected on the periodically structured porous body and to determine from a simulated response of the periodically structured porous body to the physical event the physical property.

23. The apparatus according to claim 22, wherein the physical property determination unit (113, 526) is adapted to utilize a finite element method for simulating the physical event and the response of the periodically structured porous body.

24. The apparatus according to claim 22, wherein the simulated physical event is part of a simulated physical testing procedure that provides a response indicative of a predetermined physical property.

25. The apparatus according to claim 24, wherein the simulated physical testing procedure is based on a testing procedure described in an industrial norm.

26. The apparatus according to claim 19, wherein the structural representation of a periodically structured porous body comprises structural parameters representing a geometrical shape of the periodically structured porous body, wherein the structural parameters are indicative of at least one of a lattice type, a lattice parameter, a lattice constant, a beam diameter, a unit cell size, an aspect ratio, a beam angle, and a wall thickness.

27. The apparatus according to claim 26, wherein the physical property determination unit (113, 526) is further adapted to convert the structural parameters into a digital representation of the respective periodically structured porous body and to determine the physical properties based on the digital representation of the periodically structured porous body.

28. The apparatus according to claim 19, wherein the determined physical properties of a periodically structured porous body refer to at least one of a hardness, an E-module, a density, an elongation at break, a compression stiffness at x % compression, a stress at x % elongation, a rebound, a shore hardness, a flex-modulus, a tensile strength, an impact strength, a Poisson's ratio, a tear strength, and a temperature capacity.

29. The apparatus according to claim 19, wherein the apparatus further comprises a library generation unit (114) for generating a library of physical properties of a plurality of periodically structured porous bodies based on the physical properties determined for the periodically structured porous bodies.

30. The apparatus according to claim 29, wherein the control file generator is adapted to generate the control file based on the generated library.

31. The apparatus according to claim 19, wherein the apparatus further comprises an optimization unit for optimizing a physical component, wherein the optimization unit is adapted to i) receive a target physical property of a target structured porous body, ii) compare the target physical property with the physical property determined for a periodically structured porous body by the physical property determination unit, and iii) decide, based on the comparison, whether to a) generate an amended structural representation of an amended periodically structured porous body and/or an amended material model, repeating the determination of the physical property by the physical property determination unit, and the comparison or b) select the periodically structured porous body as the target periodically structured porous body for which the control file generator generates the control file.

32. The apparatus according to claim 31, wherein the optimization unit is adapted to generate a plurality of amended structural representation of an amended periodically structured porous body and to initiate a determination of a physical property for all generated periodically structured porous bodies by the physical property determination unit to generate a library of periodically structured porous bodies from which a periodically structured porous body fulfilling the target physical property is selected and a respective control file generated by the control file generation unit.

33. A interface system for generating a control file for additive manufacturing of a physical component comprising or being at least partially made of a structural porous body, wherein the interface system comprises:
an apparatus according to claim 19, and
an interface unit configured to provide an interface with the apparatus.

34. A generation method for generating a control file for additive manufacturing of a physical component comprising or being at least partially made of a structural porous body, wherein the method comprises:
providing a structural representation for a periodically structured porous body, wherein the structural representation is indicative of a structure of the periodically structured porous body,
providing a material model, wherein the material model is indicative of a response of a material to one or more external physical influences,
determining physical properties for the periodically structured porous body, wherein a physical property for the periodically structured porous body is determined based on the structural representation of the periodically structured porous body and the material model, and
generating a control file usable for manufacturing the physical component comprising or being at least partially made of the structural porous body.

35. A computer program product for generating a control file for additive manufacturing to execute the method according to claim 34, wherein the computer program product comprises program code means for causing a generation apparatus for generating a control file for additive manufacturing of a physical component comprising or being at least partially made of a structural porous body, wherein the apparatus comprises:
a structured porous body providing unit for providing a structural representation for a periodically structured porous body, wherein the structural representation is indicative of a structure of the periodically structured porous body,
a material model providing unit for providing a material model, wherein the material model is indicative of a response of a material to one or more external physical influences,
a physical property determination unit for determining physical properties for the periodically structured porous body, wherein a physical property for the periodically structured porous body is determined based on the structural representation of the periodically structured porous body and the material model, and
a control file generator for generating a control file usable for manufacturing the physical component comprising or being at least partially made of the structural porous body.

36. A method for the manufacturing of periodically structured porous bodies for cushioning's for shoes, helmets, seats, rests, matrasses and/or protective gear comprising an apparatus according to claim 19.
